(19) United States
(12) Patent Application Publication
(10) Pub. No.: US 2024/0409138 A1
(43) Pub. Date: Dec. 12, 2024

(54) HYBRID LOCOMOTIVE WITH THROTTLE POWER BOOST

(71) Applicant: Progress Rail Locomotive Inc., LaGrange, IL (US)

(72) Inventors: James D. Seaton, Downers Grove, IL (US); Scott A. Swenson, Mokena, IL (US); Madan M. Jalla, Woodridge, IL (US); Sidarta Fornari Beltramin, Curitiba - PR (BR); Ricardo Alessandro Lempke, Uberaba-MG (BR)

(73) Assignee: Progress Rail Locomotive Inc., LaGrange, IL (US)

(21) Appl. No.: 18/207,204

(22) Filed: Jun. 8, 2023

(51) Int. Cl. B61L 3/00; B61C 7/04

(52) U.S. Cl. CPC B61L 15/0062; B61C 7/04

(57) ABSTRACT

A locomotive propelled by a hybrid power system includes a boost mode of operation accessible on-demand by the operator. When a throttle is set to deliver maximum power from a diesel-electric engine, an operator can select actuators separate from the throttle to request that a control module deliver additional electrical power from batteries. The actuators may be soft keys or a touchscreen on a computer monitor or mechanical switches as part of the locomotive cab. The actuators provide boost notches of additional power beyond the typical eight notches on the throttle at least for transient conditions, and existing locomotives may be easily and inexpensively retrofitted with the actuators.

### TECHNICAL FIELD

The present disclosure relates to a locomotive having enhanced tractive effort accessible on demand and a method of applying a boost in tractive effort to supplement that of a main locomotive engine. More specifically, the present disclosure relates to a hybrid locomotive having actuators separate from an engine throttle for an operator to select boost notches of supplemental electrical power and to a method for accessing the supplemental electrical power to apply a boost of output from a main locomotive engine to a rail.

### BACKGROUND

A train typically includes at least one locomotive for propelling the vehicle by wheels along tracks. A diesel engine often serves as the primary motive source, or prime mover, within the locomotive. An alternator with affiliated electronics generates electrical energy from the diesel engine. The electrical energy powers traction motors, which rotate the wheels.

The traction motors may also be operated as generators as the train moves, resisting rotation of the wheels and braking the locomotive, known as “dynamic braking.” The traction motors convert the kinetic energy of the wheels into electrical energy from this dynamic braking, which may be rheostatic, regenerative, or a combination of the two. In rheostatic braking, the electrical energy generated by the traction motors is directed through grid resistors and dissipated into the environment as heat. In regenerative braking, the electrical energy from braking is captured and stored in batteries. With these batteries, the locomotive has another source of electrical energy along with the diesel-electric engine for powering the traction motors and can essentially operate as a hybrid vehicle.

In legacy locomotives, an operator controls the amount of total power applied to the traction motors by sliding a throttle handle across a series of discrete settings, or notches. In many locomotives, the throttle pivots in an arc, and each notch includes a detent or stop for the handle within the pivoting. The operator can increase or decrease the total tractive-effort power applied by pivoting the handle sequentially from idle at notch setting 0 to maximum power, which is traditionally at notch setting 8. In hybrid locomotives, the eight throttle settings limit operator adjustment of the total power applied, while control electronics automatically manage the balance of that power derived from the diesel-electric engine and the batteries.

One approach for managing the delivery of electrical energy from batteries in a hybrid locomotive is described in U.S. Pat. No. 6,591,758 (“the '758 patent”). The '758 patent is directed to a hybrid energy locomotive system having an energy storage and regeneration system. According to the '758 patent, the energy storage and regeneration system captures dynamic braking energy, excess motor energy, and externally supplied energy and stores the captured energy in one or more energy storage subsystems, including a flywheel, a battery, an ultra-capacitor, or a combination of such subsystems. An energy-management system is responsive to power storage and power transfer parameters to determine present and future electrical energy storage and supply requirements. Directed to an automated system, the '758 patent does not contemplate, among other things, limitations imposed on the operator in using a legacy throttle for adjusting power and, particularly, on the inability of the operator to apply extra power to the traction motors on demand for transient conditions while operating at a maximum throttle-notch setting.

Examples of the present disclosure are directed to overcoming deficiencies of such systems.

### SUMMARY

In an aspect of the present disclosure, a power control system for a locomotive includes a throttle configured to indicate a first amount of primary power to be provided from a primary power source to one or more traction motors of the locomotive and a user-selectable actuator, separate from the throttle. The user-selectable actuator is configured to select a second amount of auxiliary power to be provided from an electrical storage to the one or more traction motors. The power control system further includes a control module configured to cause, in response to the user-selectable actuator selecting a second amount of auxiliary power, delivery of at least some of the second amount of auxiliary power to the one or more traction motors.

In another aspect of the present disclosure, a locomotive includes a diesel-electric engine, an electrical storage, traction motors coupled to the diesel-electric engine and to the electrical storage, and a cab configured to house an operator of the locomotive. The cab contains controls adjustable by the operator to affect movement of the locomotive. The controls include a throttle lever adjustable to set a total power to be provided to the traction motors for propelling the locomotive and an actuator, separate from the throttle lever, adjustable to set a second amount of auxiliary power to be provided from the electrical storage to the traction motors. The locomotive also includes a control module, coupled to the diesel-electric engine and to the electrical storage, configured to cause delivery of the second amount of auxiliary power to the traction motors, in response to the actuator being set at the second amount of auxiliary power.

In yet another aspect of the present disclosure, a method for executing a power boost in a locomotive includes receiving, from a user-activated throttle in a cab of the locomotive, a setting for diesel-engine power from a diesel-electric engine for driving traction motors of the locomotive and receiving, from a user-selectable actuator in the cab separate from the user-activated throttle, a request for a first level of the power boost for driving the traction motors. The method also includes causing a delivery of a first amount of electrical power commensurate with the first level from an electrical storage to the traction motors together with the diesel-engine power.

### BRIEF DESCRIPTION OF THE DRAWINGS

FIG. 1 is a diagrammatic side view of a locomotive with functional components of a power system in accordance with an example of the present disclosure.

FIG. 2A is a functional block diagram of a power system for propelling a locomotive with a representative traction motor in accordance with an example of the present disclosure.

FIG. 2B is a functional block diagram of additional traction motors, auxiliary motors, and auxiliary loads for the power system in FIG. 2A in accordance with an example of the present disclosure.

FIG. 3 is a plan view of a control panel within a cab of the locomotive of FIG. 1 in accordance with an example of the present disclosure.

FIG. 4 is a graph depicting results of a simulation involving on-demand boost operation in a locomotive in accordance with an example of the present disclosure.

FIG. 5 is a flowchart depicting a method of accessing on-demand boost operation in a locomotive using additional notches in accordance with an example of the present disclosure.

### DETAILED DESCRIPTION

Consistent with the principles of the present disclosure, a locomotive includes an interface for an operator to access and select a boost of engine power for increasing tractive effort from traction motors on demand. The locomotive may have a primary power subsystem in the form of a diesel-electric engine, for example, and a secondary power subsystem in the form of an electrical storage, such as batteries and fuel cells, both of which subsystems may feed electrical power to the traction motors, as well as to accessory loads. When a throttle handle is in the maximum setting, drawing full power from the diesel-electric engine, the operator may activate one or more actuators separate from the throttle, possibly in the form of soft keys or a touchscreen on a computer monitor, for releasing additional power from the secondary power subsystem to the traction motors. Because a typical locomotive has traction motors with a higher power rating than the diesel-electric engine that drives them, the traction motors can apply the additional power released from the secondary power subsystem on demand by the operator at least during transient conditions. The following describes several examples for carrying out the principles of this disclosure. Wherever possible, the same reference numbers will be used throughout the drawings to refer to same or like parts.

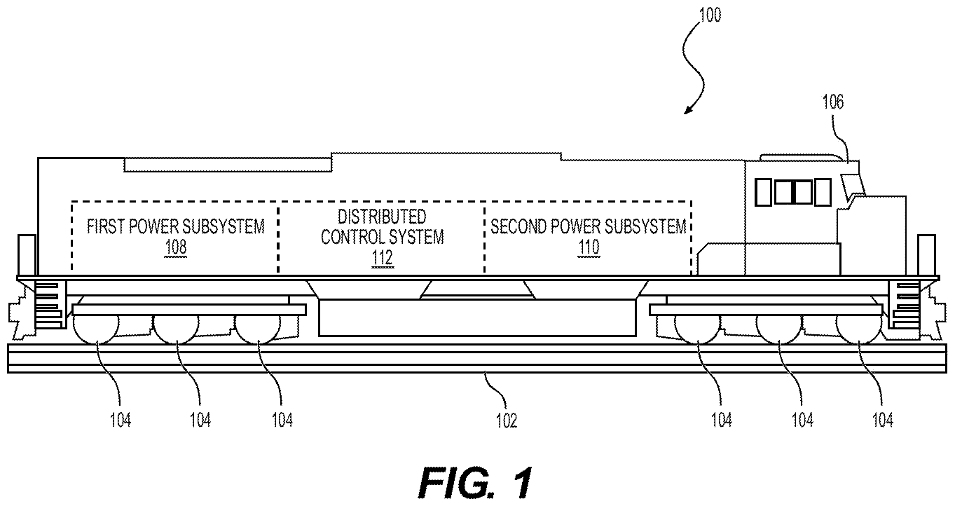

FIG. 1 illustrates a diagrammatic side view of a locomotive 100 as one example suitable for carrying out the principles discussed in the present disclosure. Exemplary locomotive 100 functions as a rail vehicle and travels along tracks or rails 102 from a source to a destination (from left to right in FIG. 1) using wheels 104. Although depicted as a single car, locomotive 100 may be part of a group of locomotives or affiliated rail vehicles functioning together as a consist. Accordingly, the structure and function of locomotive 100 may, in some examples, be distributed across a variety of railroad cars that are coupled together directly or indirectly. In this way, a train including locomotive 100 may have a lead consist of powered locomotives, including locomotive 100 and one or more other interconnected powered units (not shown), one or more remote or trailing consists of powered locomotives (not shown), and additional non-powered units (not shown). “Powered units” refers to rail cars that are capable of self-propulsion, such as locomotive 100. “Non-powered units” refers to rail cars that are incapable of self-propulsion, but which may otherwise receive electric power for other services.

A cab 106 is positioned at a front of locomotive 100 facing the direction of travel along rails 102. The operator, or conductor, of locomotive 100 is stationed within cab 106 during operation. As discussed further below, cab 106 may include a workstation with various human-machine interfaces, such as controls, instruments, and indicators, useful for operating locomotive 100.

For propulsion, locomotive 100 contains a power system that includes at least a first power subsystem 108, a second power subsystem 110, and a distributed control system 112. In some examples, locomotive 100 functions under propulsion to drive wheels 104 from input by first power subsystem 108 and second power subsystem 110 operating either together or alternately. Second power subsystem 110 may operate as a supplemental or backup source of power to first power subsystem 108, such as when locomotive 100 needs additional tractive effort, when fuel levels or environmental regulations dictate certain operating conditions, or other situations known to those of ordinary skill in the field. Distributed control system 112 helps coordinate and balance the contributions of power for locomotive 100 between first power subsystem 108 and second power subsystem 110 under computer control for the particular rail vehicle and its mission.

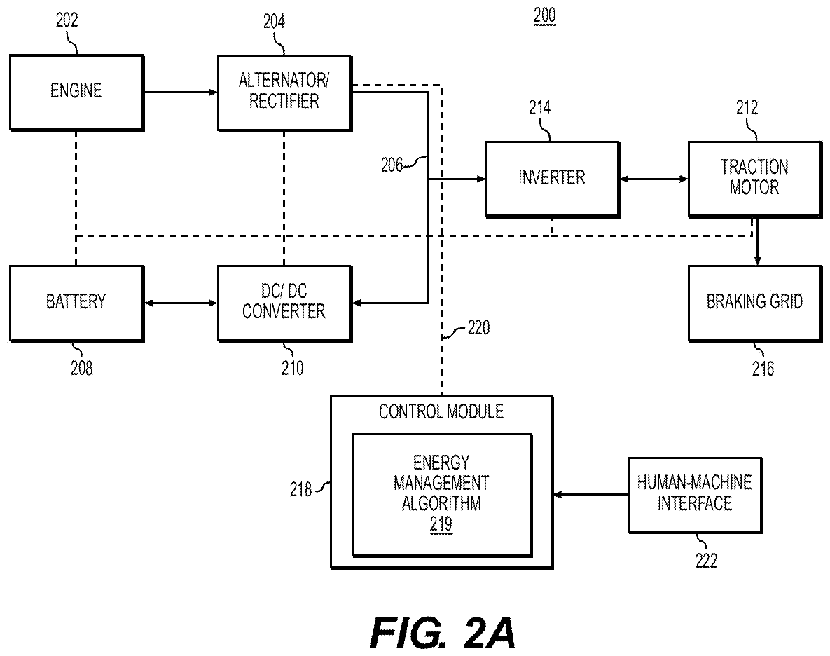

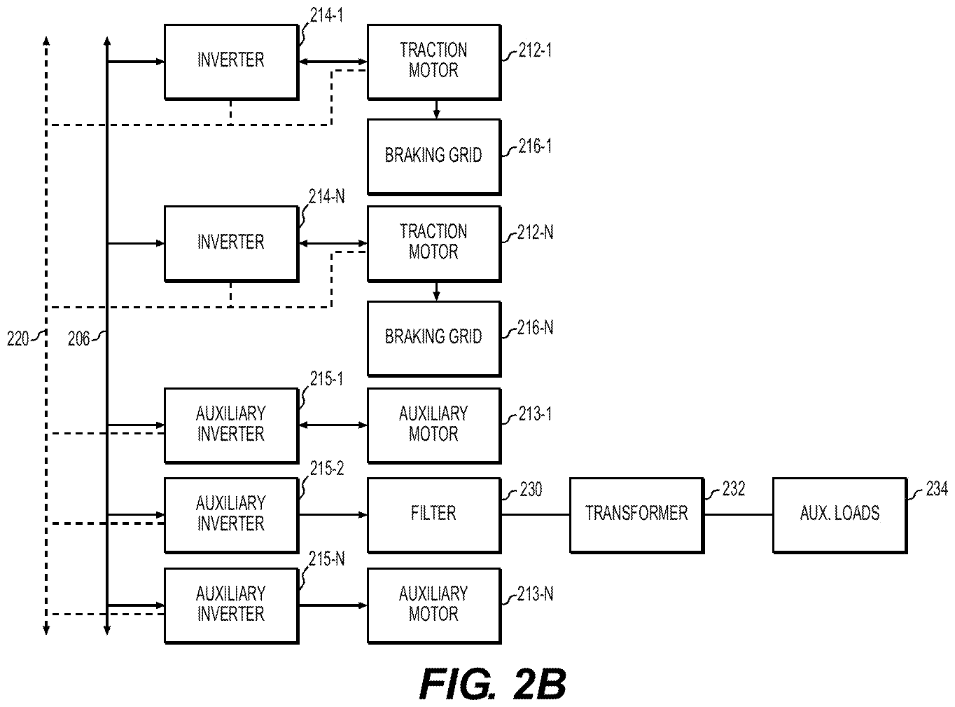

While FIG. 1 provides a general overview of components of locomotive 100 relevant to this disclosure, FIG. 2A provides a functional block diagram 200 of general components within first power subsystem 108, second power subsystem 110, and distributed control system 112, in conjunction with other features for providing an on-demand boost mode for locomotive 100 of the present disclosure. In some examples, first power subsystem 108 of FIG. 1 is generally embodied in an internal combustion engine 202 that burns fuel to propel locomotive 100. In some implementations, engine 202 is a diesel-electric engine, such as a uniflow two-stroke diesel engine system. Typically, engine 202 comprises a relatively large diesel engine, for example, having 4500 horsepower (HP). Among examples, engine 202 may be one of the EMD 710 and 1010J series engines or Caterpillar C175 and 3500 series engines. Alternatively, engine 202 may be a four-stroke internal combustion engine. In general, engine 202 may be any engine running on solid, liquid, or gaseous fuel.

The engine 202 generates a torque that is transmitted to an alternator/rectifier 204 along a drive shaft. As part of first power subsystem 108, the alternator/rectifier 204 at first converts the mechanical or kinetic energy from the torque to electrical energy in the form of alternating current (AC) voltage. The alternator/rectifier 204 then also contains silicon diode rectifiers or similar electrical components sufficient to convert the AC voltage to a direct current (DC) voltage. Additional components may be included with an alternator/rectifier 204 to provide a stable and consistent DC voltage having desired characteristics in a manner known by those of ordinary skill in the field. The DC voltage resulting from alternator/rectifier 204 is then supplied to a DC bus 206 for distribution to other elements of the power system of locomotive 100.

In some examples, second power subsystem 110 of FIG. 1 is generally embodied in an electrical storage, or battery 208, that may also provide a source of DC voltage to DC bus 206. The battery 208 may include one or more batteries, capacitors, super-capacitors, ultra-capacitors, flywheels, accumulators, or other mechanisms for storing electrical energy known to those of ordinary skill in the field. Battery 208 may be a Li-Ion propulsion battery, or may provide energy from alternative energy source such as hydrogen. A DC/DC converter 210 is configured between battery 208 and DC bus 206 as part of second power subsystem 110 to accommodate a difference in voltage handled by battery 208 and DC bus 206. As with engine 202 and alternator/rectifier 204, battery 208 may provide an alternative or supplemental source of electrical energy for DC bus 206. Additionally, battery 208 may be charged during operation of locomotive 100 via DC bus 206 according to processes known to those of ordinary skill in the art and referred to in part below.

In addition to coupling engine 202 within first power subsystem 108 and battery 208 within second power subsystem 110, DC bus 206 also couples those power subsystems with at least one electrical traction motor 212. Traction motor 212 provides final propulsion to wheels 104 from electrical power received from the power system. Typically, one traction motor 212 is disposed in locomotive 100 in proximity to rails 102 so as to rotate an axle driving a pair of wheels 104.

Representative traction motor 212 may be an alternating current (AC) traction motor or a direct current (DC) traction motor. When traction motor 212 is an AC traction motor, alternator/rectifier 204 provides DC voltage as the primary power source to DC bus 206, and inverter 214 converts the DC voltage on DC bus 206 to AC voltage to provide electrical power in the appropriate form for traction motor 212. In this example, inverter 214 may include one or more inverters and other components known to those skilled in the field for providing the appropriate electrical conversion based on the needs of traction motor 212. When traction motor 212 is a DC traction motor, inverter 214 may be a converter module having DC chopper circuits and affiliated electrical devices to convert a constant DC electrical voltage from DC bus 206 into a variable DC electrical power source appropriate for the DC traction motor. Typically, the conversion of DC electrical power for use by DC traction motors includes using pulse width modulation (PWM) within DC/DC converter 210.

In addition to operating as a motor, in which traction motor 212 receives electrical power from DC bus 206 to generate torque on an axle of wheels 104 to propel locomotive 100, traction motor 212 may be operable as a generator, in which torque on the axle from the moving locomotive 100 causes traction motor 212 to generate electrical power. When acting as a generator, traction motor 212 may provide dynamic braking to resist rotation of wheels 104 for the moving locomotive 100. Dynamic braking may provide smoother deceleration for locomotive 100 than would be provided by mechanical or pneumatic braking using disk or drum brakes. In addition, as a generator, traction motor 212 provides electrical power through inverter 214 to DC bus 206, which may be stored, otherwise used by locomotive 100 for various purposes, or dissipated. Specifically, in one form, dynamic braking by traction motor 212 may be rheostatic, where the electrical power generated by traction motor 212 is captured by a grouping of resistors and affiliated components within a braking grid 216 and dissipated as heat. In another form, dynamic braking by traction motor 212 may be regenerative, where the electrical power generated by traction motor 212 is recaptured and stored within battery 208 for further use by locomotive 100.

As discussed above, FIG. 2A illustrates representative components of first power subsystem 108 and second power subsystem 110 for locomotive 100. FIG. 2B provides further detail about exemplary electrical loads within locomotive 100 to be powered by first power subsystem 108 and second power subsystem 110. For instance, while FIG. 2A depicts a representative inverter 214, traction motor 212, and braking grid 216, FIG. 2B illustrates that locomotive 100 typically contains several of each of these components, shown as inverter 214-1, traction motor 212-1, braking grid 216-1, inverter 214-N, traction motor 212-N, and braking grid 216-N. As will be appreciated, this nomenclature indicates that a plurality of each of these components may be present in locomotive 100 at a quantity depending on the implementation. In addition, locomotive 100 typically includes one or more auxiliary inverters and auxiliary motors for driving ancillary equipment within locomotive 100. These components are designated in FIG. 2B as auxiliary inverter 215-1 and auxiliary inverter 215-N and as auxiliary motor 213-1 and auxiliary motor 213-N. Further, an auxiliary inverter 215-2 may be provided to drive auxiliary loads 234, via a filter 230 and a transformer 232. Auxiliary loads 234 represent any ancillary electrical loads within locomotive 100 or within its associated non-powered units.

Referring again to FIG. 2A, in some examples, a control module 218 as a subsystem of distributed control system 112 coordinates the activities, modes, timing, and other operations for the various components within the power system of locomotive 100. As generally embodied in FIG. 2A, control module 218 may be a microprocessor-based computer architecture having one or more memories that store computer-implemented instructions executed by one or more processors to provide signals via control bus 220 to equipment within locomotive 100 for controlling their operation. In some implementations, the control module 218 is communicatively coupled through digital or analog electrical signaling with the engine 202, battery 208, traction motor 212, braking subsystems, input devices, actuators, circuit breakers, and other devices and hardware used to control operation of various components and subsystems on locomotive 100.

For example, control module 218 is coupled communicatively with traction motor 212 and may include an energy-management algorithm 219. When executed by one or more affiliated processors, energy-management algorithm 219 may function to switch the operating mode of traction motor 212 from a motor mode, during which traction motor 212 receives electrical power from DC bus 206 to drive wheels 104, to a generator mode, during which traction motor 212 generates electrical power during dynamic braking and provides that power back to DC bus 206. In other examples, control module 218 monitors operating conditions for locomotive 100 and provides commands to balance the operation of first power subsystem 108 and second power subsystem 110. For example, energy-management algorithm 219, along with one or more other optional algorithms or routines executed by control module 218, may determine and control a percentage of electrical power provided from engine 202 or from battery 208 over a given time and in certain situations for driving wheels 104 in a hybrid arrangement. The balance of power is typically controlled automatically based on energy-management algorithm 219 following energy-management protocols and changing operating conditions, and may remain constant during a journey for locomotive 100 or may change over time. One of ordinary skill in the field will recognize that the various functions performed by control module 218 may be performed by one or more processing modules or controllers through the use of hardware, software, firmware, or various combinations thereof.

As depicted in FIG. 2A, control module 218 receives input from an operator of locomotive 100 via a human-machine interface (HMI) 220. HMI 220 enables the operator to control or otherwise affect the operation of the power system for locomotive 100, such as starting, stopping, and accelerating engine 202, applying dynamic braking using traction motor 212, and other functions. In some examples, HMI 220 is disposed within, or at least communicatively coupled with, cab 106 and may comprise a variety of instruments and controls, such as a throttle, a directional control lever, a dynamic braking control, and one or more computer displays. From these and other instruments and controls of HMI 220, operating commands are provided to control module 218 for managing behavior of locomotive 100.

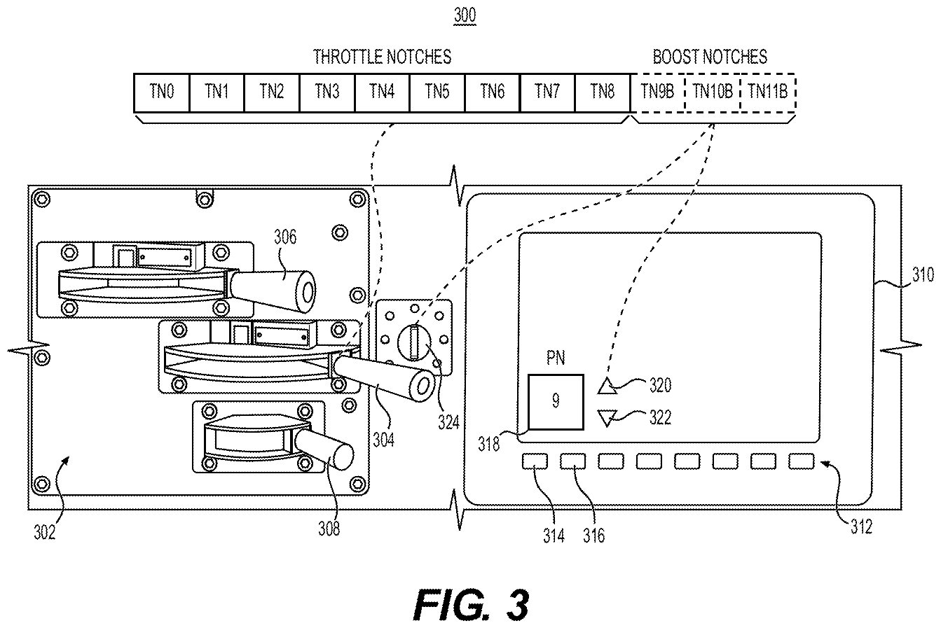

As exemplified in FIG. 3, at least a portion of HMI 220 may be implemented through a control panel 300 within cab 106 of locomotive 100. In a typical arrangement, control panel 300 is situated as part of a workstation for the operator. In some examples, control panel 300 is incorporated in a dashboard in cab 106 within the operator's field of view below a windshield and generally facing in the direction of travel of locomotive 100. As generally embodied in FIG. 3, control panel 300 comprises a portion of HMI 220 and includes mechanical and electrical/computer interfaces for providing input to control module 218. Although not shown in FIG. 3, control panel 300 may include many other controls and instruments for use by the operator readily known to those of ordinary skill in the field.

Within control panel 300, mechanical controls 302 are illustrated clustered at a left side. Mechanical controls 302 represent traditional controls present in many legacy locomotives. For example, mechanical controls 302 may include a throttle handle, an automatic brake control, an independent brake handle, a generator switch, a lighting control, and/or other controls. These and other operational control devices may embody levers, knobs, switches, buttons, slides, handles, touchscreens, and soft keys, among other types of controls.

Although implementations may vary, as selectively illustrated in FIG. 3, certain legacy controls include handled levers that may be pivoted horizontally about a vertical axis within control panel 300. The operator of locomotive 100 can slide the handled levers left or right to adjust a function. For example, in the center of mechanical controls 302 in FIG. 3, a throttle 304 has a handle that the operator can grasp and move horizontally from right to left to adjust the total power delivered to representative traction motor 212. Although shown in FIG. 3 as a slidable handle, throttle 304 may alternatively be a switch, dial, slide, handle, knob, lever, pedal, or any other type of control device.

In the disclosed example, consistent with legacy locomotives, throttle 304 begins at a far right of its range of movement at an engine idle position and may be movable to a maximum position at the far left of its range of movement. Across that range, throttle 304 is movable through a sequence of stops or detents corresponding to throttle notch positions (TN). In typical examples for legacy locomotives, beyond a starting idle position (essentially TN0), throttle 304 will stop at eight notch positions (e.g., TN1-TN8) that each corresponds to increasing amounts of power selected for delivery to traction motor 212. Accordingly, throttle 304 moved through notches TN1-TN7 to reach its far left position at TN8 will provide a maximum available power selectable by the operator for delivery to traction motor 212. As known to those of ordinary skill in the field, algorithms within control module 218, such as energy-management algorithm 219, may automatically determine the contribution of the selected total power delivered to traction motor 212 from engine 202 and from battery 208 at a given time.

As further indicated in FIG. 3, mechanical controls 302 may include additional levers for operating locomotive 100. For instance, dynamic brake 306 enables the operator to engage dynamic braking by sliding a lever on control panel 300 accordingly. Also, at a bottom of mechanical controls 302, an operator may slide a reverser 308 to change direction of locomotive 100. Typically, reverser 308 directs locomotive 100 to be in neutral when in a center position of its range of motion, to be in reverse when in a leftmost position, and to be in forward when in a rightmost position.

Additionally, control panel 300 includes at least one computer terminal or monitor 310 as shown in FIG. 3. Monitor 310 may be configured to receive input from the operator to give computer or electronic instructions to control module 218 for controlling locomotive 100. Although not fully illustrated, monitor 310 may include a keyboard, mouse, touchscreen, directional pad, selector buttons, or any other suitable features for recording manually entered data. Accordingly, monitor 310 permits the operator to learn about and monitor the performance of locomotive 100 from information shown on a screen, while possibly also interacting with monitor 310 to affect behavior of the train.

Additionally, or alternatively, monitor 310 may be configured to display data from the outputs of one or more of machine gauges, indicators, sensors, and controls as a consolidated or integrated source for operator information. As such, monitor 310 may include a graphical user interface (GUI) configured to display information associated with the train. The GUI may be a graphic display tool including menus (e.g., drop-down menus), modules, buttons, soft keys, toolbars, text boxes, field boxes, windows, and other means to facilitate the conveyance and transfer of information between a user and HMI 220.

While HMI 220 via mechanical controls 302 and monitor 310 enables an operator to modify many features of locomotive 100, other features of current locomotives are reserved for computer control. For instance, although throttle 304 is movable to adjust total power delivered to traction motor 212, a contribution of that power from engine 202 or battery 208 tends to remain under computer command according to energy-management algorithm 219. That algorithm optimizes the balance of stored battery power and engine output to provide appropriate tractive effort for locomotive 100 while factoring in a multitude of considerations, such as terrain over a planned route, fuel usage, battery storage, power capacity, and exhaust and environmental concerns. At times, however, an operator may need the flexibility to access additional power for locomotive 100 not contemplated by, or restricted by, energy-management algorithm 219, such as when climbing an unexpected incline, needing to travel quickly through a tunnel, or seeking a higher rate of acceleration.

In accordance with the present disclosure and as generally embodied in FIG. 3, locomotive 100 enables the operator to request on demand a boost of extra engine power for the traction motors as available from the electrical storage. As discussed above, conventional locomotives possess fixed throttle notches, generally of TN1-TN8, for adjusting the output primarily of engine 202. When throttle 304 has reached TN8, no further tractive effort may normally be available to the operator from engine 202. However, in locomotives having a hybrid architecture, such as depicted in FIG. 2A, additional power capacity often exists within traction motor 212. The second power subsystem 110 can provide additional power to the traction motor 212 for a temporary basis, until a time when certain physical limitations are reached. Physical limitations may include ambient temperature, state of charge of the battery 208, temperature of the battery 208, and thermal limitations of traction motor 212 such as insulation rating, and traction motor blower air flow capacity. On the other hand, energy-management algorithm 219 operating locomotives in a regenerative braking configuration typically retains and restores electrical energy within battery 208 available for driving traction motor 212.

Consistent with the principles of the present disclosure, HMI 220 and control panel 300 of the present disclosure include selectable inputs for the operator to release additional energy present in battery 208 on demand termed “boost notches.” In some examples, while throttle 304 of FIG. 3 may have a maximum setting for engine 202 of TN8, the boost notches may provide higher power settings for the operator to access that provide tractive effort via second power subsystem 110 that is beyond the capacity of engine 202. Boost notches do not physically appear on a conventional or legacy version of throttle 304, but are added within cab 106 for an operator to access. Each boost notch, as with each physical notch in throttle 304, may correspond to a fixed or predetermined amount of total power expected to be added to traction motor 212 from the power system.

In one example, boost notches may be accessed via monitor 310. Adjustments to software relating to HMI 220 may provide a display of one or more software switches on monitor 310 for the operator to select. In one option, the one or more software switches may be implemented using one or more soft keys 312 integrated within monitor 310. Thus, one of the soft keys 312, such as an increment key 314, may be programmed and reserved to increment the prevailing total power level by a predetermined amount when selected. Therefore, if throttle 304 were at TN8, selecting to increment the total power level via increment key 314 would invoke a first boost notch and move the total power level to a boost notch 9, which may be designated “TN9B.” With this activation, HMI 220 and control module 218 provide appropriate commands via control bus 220 to cause delivery of additional stored electrical power of the predetermined quantity from battery 208 to traction motor 212 via DC bus 206. As a result, traction motor 212 would receive a new total power for propulsion at an enhanced level beyond what had been TN8 (i.e., now at TN9B). Monitor 310 would then provide feedback to the operator indicating the current boost notch level, such as represented by notch level icon 318 in FIG. 3 showing the current boost notch level of TN9B.

If additional power boost were desired, the operator could again select increment key 314. In response, control module 218 would provide appropriate commands via control bus 220 to cause battery 208 to release further stored electrical energy of a predetermined quantity so that traction motor 212 operates at a further boosted level of TN10B. Several boosted levels consistent with this sequence could be implemented, as will be appreciated by those skilled in the field.

The amount of power provided to representative traction motor 212 for a boost notch, such as TN9B, may vary between locomotives based on the particular implementation and may vary between boost notches on the same locomotive, such as between TN9B and TN10B. In general, the maximum power that may be applied in boost operation-if available at the time from battery 208 in second power subsystem 110—is the difference between the rated power for traction motor 212 and the maximum output power from engine 202. For example, diesel engine 202 in some legacy locomotives may have a maximum output power of 4300 HP, which an operator may access for traction motor 212 by setting throttle 304 at its maximum position of TN8. Traction motor 212 in such a locomotive may have a rated power of 7000 HP. Therefore, in theory, the locomotive would have a boost capacity of 2700 HP, although physical limitations may decrease that amount. Moreover, the amount of power provided for each boost notch may be divided across this 2700 HP. For instance, the first boost notch of TN9B could be considered as an extension of throttle 304 at a proportionally higher power level at a throttle notch 9, such that TN9B might add about 700-1,000 HP to give a total power output to traction motor 212 of 5000 HP. A second boost notch could be considered throttle notch 10 at a proportionally higher power level (“TN10B”), providing a total power output for locomotive 100 of 6000 HP. As shown in FIG. 3, a third boost notch could be considered throttle notch 11 at a proportionally higher power level (“TN11B”), providing a maximum total power output for locomotive 100 of 7000 HP. Other variations to the boost notches will be apparent to those of ordinary skill in the art, such as notches have nonproportional power levels and a control panel 300 having fewer or more than three boost notches.

After operating locomotive 100 at an accelerated rate within one of the boost notches, the operator may decrease the tractive effort from traction motor 212 by decreasing the boost notches. For instance, a decrement key 316 integrated within monitor 310 is selected to cause control module 218 to decrease the boosted electrical power provided from battery 208 by one level, i.e., from TN10B to TN9B. As well, HMI 220 would update notch level icon 318 to reflect the new boost notch level for locomotive 100. If further deceleration is desired, another press of decrement key 316 would bring the total power level for traction motor 212 back to TN8, causing energy-management algorithm 219 to end the application of on-demand boost power. At that point, a further decrease of locomotive power would occur by the operator sliding throttle 304 in a conventional manner to any position between TN8-TN0 to adjust the power output from diesel engine 202.

In some implementations, operator selection of increment key 314 will cause control module 218 to override energy-management algorithm 219, or will cause energy-management algorithm 219 to modify delivery of power from battery 208 under normal operation, so that control module 218 may then instruct the delivery of extra power to traction motor 212 from battery 208 as commanded by the boost notch level. Notwithstanding the instructions from control module 218, the delivery of extra power to traction motor 212 in response to operator selection of increment key 314 will generally depend on storage capacity within battery 208. In one situation, locomotive 100 may not have stored sufficient electrical energy to operate in a boost mode when selection of increment key 314 occurs, in which case locomotive 100 will not be able to enter the boost mode as requested.

In some examples, locomotive 100 is configured to ensure capacity for delivering at least some enhanced power beyond TN8. For instance, energy management algorithm 219 may be designed to preserve a minimum level of charge within battery 208 during the running of locomotive 100 for delivery to traction motor 212 in response to at least one selection of increment key 314. In other examples, locomotive 100 may include a supplemental electrical storage other than battery 208 (not shown in FIG. 2A) similarly coupled to DC bus 206 for providing electrical power to traction motor 212 in response to a command from increment key 314. The supplemental electrical storage may retain electrical energy of a predetermined quantity sufficient to respond to the demands of one or more of the boost notches. As with battery 208, the supplemental electrical storage may be refilled using regenerative braking or through other charging mechanisms known to those of ordinary skill in the field.

Regardless of the source of boost power for traction motor 212, a duration of a power boost after engine 202 is operating at maximum output will be limited to the stored energy capacity. Sufficient electrical energy may be stored for locomotive 100 to operate in a boost mode, but, depending on the arrangement for recharging the electrical storage devices, after a passage of time operating in a boost notch that stored electrical energy may become depleted. As a result, the enhanced power delivery will end, control module 218 will return power delivery to energy-management algorithm 219, and locomotive 100 will revert to operating according to the notch settings of throttle 304, i.e., TN8.

In some examples, control module 218 of locomotive 100 is configured to guard against overheating of traction motor 212 while operating in the elevated power condition of a boost mode. In particular, traction motor 212 will have thermal ratings at which it can safely operate, such as 200 degrees C., for a certain period of time and load. When operated above the thermal ratings, traction motor 212 is at risk of having its windings fail. Accordingly, control module 218 may be configured to evaluate the power being delivered to traction motor 212 in a boost situation and to determine whether the delivered power will result in a temperature above the thermal ratings of traction motor 212. If so, control module 218 may curtail the boost operation and return operation of locomotive 100 to TN8.

In other examples, control module 218 is configured to override or interrupt the boost mode of operation for locomotive 100 if the operator decelerates engine 202 using throttle 304. For instance, if locomotive 100 is operating in TH9B and the operator slides throttle 304 from TN8 to TN7, control module 218 will interrupt the balance of power delivered to traction motor 212 between engine 202 at full power and battery 208 at TH9B. Instead, control module 218 may revert to operating locomotive 100 based on engine 202 powered according to TN7 with contribution from battery 208 determined by a predetermined algorithm, such as energy-management algorithm 219 for control module 218.

Returning to examples for accessing on-demand boost, alternative to using soft keys 312, HMI 220 may include a touchscreen display and be configured to receive operator input from finger touches on the display. For instance, as shown in FIG. 3, to access power boost levels, monitor 310 may additionally or alternatively include an increment icon 320, such as in the shape of an up arrow or an upwardly pointing triangle. HMI 220 would be programmed such that receiving a finger press on increment icon 320 would cause control signal from control module 218 to shift traction motor 212 into an enhanced power level, such as from TN8 to TN9B. Additional presses of increment icon 320 would provide further elevations of total power applied to traction motor 212, which would likewise be indicated by notch level icon 318. Conversely, monitor 310 may also include a decrement icon 322, such as in the shape of a down arrow or a downwardly pointing triangle. A press of decrement icon 322 would decrement the power level to traction motor 212 by one boost notch, e.g., from TN9B to TN8, which would be reflected by notch level icon 318 on monitor 310.

As will be appreciated, implementation of boost notches for achieving on-demand boost using monitor 310 in this manner generally involves inexpensive updates to software associated with HMI 220 and control module 218. Because physical changes to cab 106, throttle 304, and other mechanical controls 302 can generally be avoided, retrofitting existing locomotives with the capability for on-demand boost is relatively easy and inexpensive. Other techniques for implementing boost controls as disclosed above within monitor 310 as software options and graphical user interfaces, whether with other soft keys, a keypad or keyboard, through a touchscreen, or through a smartphone or other wireless device, will be apparent to those of ordinary skill in the field.

While software updates to control panel 300 and HMI 220 provide a highly efficient means to extend power selection beyond TN8 for throttle 304, particularly for existing locomotives, FIG. 3 also illustrates at least one option for implementing on-demand boost using physical controls. In particular, as embodied in FIG. 3, boost selector 324 provides an optional extension of throttle 304 for choosing sequential levels of enhanced output power for traction motor 212. Boost selector 324 may take the form of a rotary dial or switch, in one example. In its normal state while throttle 304 is in one of TN1-7, boost selector 324 is in a neutral setting where it does not engage any activity within HMI 220. With throttle 304 in TN8, however, the operator may adjust boost selector 324 sequentially through different boost levels. In the example of a rotary switch or dial, the operator may rotate boost selector 324 from its neutral state to a first position associated with a stop or detent at a first boost notch, i.e., TN9B. With throttle 304 in TN8 and boost selector 324 at TN9B, HMI 220 may be wired or otherwise programmed to coordinate with control module 218 to cause an elevation in the total output power to traction motor 212 based on excess energy being provided from battery 208. Similarly, boost selector 324 may be changed to another boost setting, such as TN10B, whereby HMI 220 and control module 218 will cause an additional incremental increase in output power as requested by the operator. In the converse, the operator may sequentially decrease the boost levels by rotating or otherwise changing the setting of boost selector 324 to move from TN10B to TN9B. Then again, if desired, boost selector 324 may be switched from TN9B to the neutral position, where power output again becomes dictated by throttle 304.

It will be appreciated that boost selector 324 as a physical device may take many shapes and forms without departing from the scope of the present disclosure. For example, while discussed in terms of a rotary dial, boost selector 324 could be a sliding switch, a rocker switch, or one or more toggle switches, or other similar devices. Operation of boost selector 324 could also be integrated via HMI 220 with monitor 310 such that, for instance, feedback on the status of the boost notch and affiliated information is displayed.

Finally, as yet another option, on-demand boost could also be implemented using an extended version of throttle 304. In particular, an existing or legacy throttle 304 that has a fixed number of power levels, such as TN0-TN8, could be replaced with an extended version of the throttle that has boost notches incorporated as additional detents in the range of motion for the handle. Thus, if the extended version of the throttle at its rightmost position sets engine 202 to idle, sliding the handle to the left will sequentially pass through notches TN1-TN8 and then will be further movable through boost notches, such as TN9B-TN11B. Accommodating an extended version for throttle 304 for a legacy locomotive would involve at least replacement of the existing throttle and associated switching mechanisms.

It will be appreciated that other mechanisms may be employed to provide operator selection of a power boost beyond a legacy throttle. The present disclosure is not intended to be limiting to the particular switching or selection options available to an operator as an auxiliary input to HMI 220.

Although boost operation has been described as an extension of maximum power from engine 202 at notch TN8 on throttle 304 by using boost notches at levels such as TN9B-TN11B, in some implementations, an operator may access boost power from battery 208 when engine 202 is operating at less than maximum power, i.e., below TN8 on throttle 304. In one example, an operator may limit the output of engine 202 when running locomotive 100 in sensitive environmental areas, such as in a depot or near a residential area, to reduce generation of noise and exhaust. Thus, throttle 304 may be set at TN3 for prevention even though the operator may wish to have higher tractive effort from locomotive 100. In that situation, the operator may actuate one or more boost notches within control panel 300, such as through increment key 314 within monitor 310 or through boost selector 324, to boost the tractive effort even at notch setting TN3. Alternatively, additional selectors may be incorporated within control panel 300 for activating boost levels when the power of engine 202 is less than TN8. If the operator were to activate the appropriate selector twice, such as increment key 314, energy-management algorithm 219 within control module 218 would provide corresponding additional power from battery 208 to traction motor 212, resulting in a tractive effort equivalent to notch TN5 on throttle 304, i.e., at a boost setting of TN5B. This enhanced power setting of TN5B could be indicated within notch level icon 318 on monitor 310. As a result, by activating boost notches through an input on control panel 300, the operator may deliver enhanced tractive power equivalent to TN5 on demand while drawing power at a lower level of TN3 from engine 202 without generating extra diesel exhaust and noise.

As another example, boost notches are available to the operator when control module 218 has impaired, or artificially limited, the power output of engine 202. In one situation, energy-management algorithm 219 within control module 218 may impair or derate the engine output when locomotive 100 operates in a tunnel or similar environment. High ambient temperatures may cause the engine output to be derated to avoid overheating of oil and water within the power system. In this derating, control module 218 may “knock down” the output power set by throttle 304, causing power from engine 202 to be lower than the notch setting. Thus, while throttle 304 may be at notch TN5, control module 218 may decrease the output of engine 202 to the equivalent of TN3. By accessing boost selectors within control panel 300, such as increment key 314, the operator of locomotive 100 may essentially override the power knockdown. For instance, by twice actuating increment key 314 during an engine derating or power knockdown while in notch TN5, the operator could deliver two boost levels of power from battery 208. These two boost levels may, on demand, cause locomotive 100 to have an enhanced tractive effort equivalent to TN5 (i.e., TN5B) while drawing power at a lower level of TN3 from engine 202 to avoid overheating. Alternatively, energy-management algorithm 219 could be programmed to apply boost levels automatically to offset the power knockdown. Additional examples of boosting the tractive effort when engine 202 is operating at less than maximum power, whether due to an operator setting of throttle 304 or a knockdown of engine power by control module 218, will be within the knowledge of those of ordinary skill in the field.

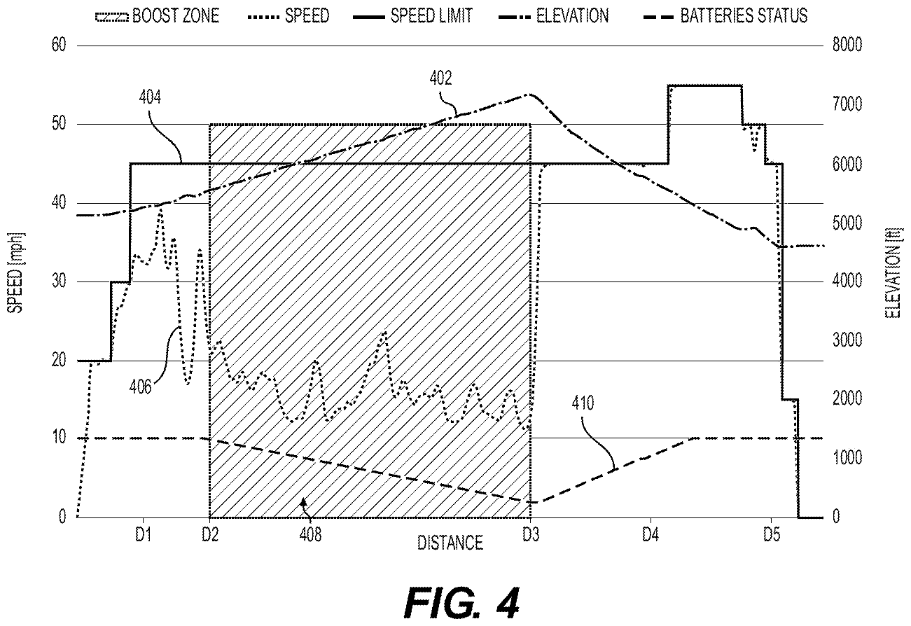

FIG. 4 is a graph from a boost simulation 400 of locomotive 100 traversing an incline and then a decline of terrain while accessing a boost mode according to some of the examples discussed above. In FIG. 4, locomotive 100 travels along rails 102 that have an elevation 402, which rises from about 5000 feet (right vertical axis) at a location or distance D1 (lower horizontal axis), to a peak of about 7000 feet at a distance D3, and then to a finishing elevation of about 4700 feet at D5. While traveling along elevation 402, locomotive 100 has a speed limit 404 set by rail system based on the infrastructure of rails 102 and the environment, which the operator wishes to match. Speed limit 404 essentially begins at distance D1 at about 40 mph and continues to distance D4 where speed limit 404 increases to about 55 mph (left vertical axis). Within the graph of FIG. 4, speed 406 indicates actual speed of locomotive 100 according to its simulated behavior based on a fixed load across the programmed elevation 402.

As shown in FIG. 4, at a stabilized beginning for the simulation at distance D1, locomotive 100 has a speed 406 of 30 mph roughly matching speed limit 404 for the track. As speed limit 404 has a step increase to about 45 mph, locomotive 100 attempts to accelerate, but, as shown by speed 406, increasing elevation 402 prevents locomotive 100 from matching speed limit 404. Speed 406 then fluctuates between about 38 mph and 33 mph. As elevation 402 continues to increase, the load of locomotive 100 causes speed 406 generally to decrease as low as about 18 mph between distances D1 and D2. To counteract the slow down of locomotive 100, the operator at distance D2 activates a boost notch, such as by actuating increment key 314, increment icon 320, or boost selector 324 discussed above for FIG. 3. Accordingly, control module 218 and energy-management algorithm 219 place locomotive 100 into a boost zone 408 and provide supplemental electrical power from battery 208 to representative traction motor 212. While locomotive 100 travels from distance D2 to distance D3 in FIG. 4, boost zone 408 is effective and helps counteract the continual increase in elevation 402. FIG. 4 indicates that during operation across boost zone 408, speed 406 essentially becomes stabilized between about 24 mph and 12 mph.

FIG. 4 also illustrates a batteries status at 410 as locomotive travels from distance D1 to D5. At the outset, batteries status 410 is at 100% charge. When the operator activates a boost notch at distance D2, such as to enter notch TN9B, batteries status begins to be depleted as stored power is diverted to traction motor 212. This decrease in batteries status 410 continues throughout boost zone 408 until locomotive 100 reaches the peak of elevation 402 at distance D3. At this point, supplemental tractive effort is no longer need, and as locomotive 100 crests the peak, boost zone 408 is deactivated. This deactivation may occur, for example, from the operator decreasing the boost notch, such as by selecting decrement key 316, decrement icon 322, or boost selector 324, or by pulling back throttle 304 to a lower notch setting, whereby energy-management algorithm 219 may discontinue the boost functionality. Alternatively, deactivation of boost zone 408 could occur by the operator engaging braking mechanisms due to the rapid increase in speed occurring at distance D3, which may also cause control module 218 to discontinue boost functionality.

As locomotive 100 begins its descent along elevation 402, speed 406 increases to match speed limit 404. The operator may engage dynamic brake 306 (FIG. 3), which activates regenerative braking and charging of battery 208. Accordingly, batteries status 410 begins to rise from a low of about 20% at distance D3 at the peak of elevation 402 during the descent between distance D3 and D4. At distance D4, battery 208 is returned essentially to a full charge of 100%, as reflected by batteries status 410 in FIG. 4. Between distance D4 and D5, locomotive D4 may match an increase in speed limit 404 using the output of engine 202 without recourse to boost zone 408, as elevation 402 continues to decline.

It will be appreciated that boost simulation 400 is but one example of an operating condition for locomotive 100 across a terrain in which supplemental power on demand from battery 212 may be advantageous. Other situations, such as the application of additional boost notches or the use of a boost zone at less than full output from engine 202, will be understood from the principles described in this disclosure.

Turning from the architecture of locomotive 100 and options for implementing boost notches within control panel 300 as illustrated in FIGS. 1-4, FIG. 5 is a flowchart of a representative method 500 for accessing on-demand boost operation in a locomotive using boost notches. This process 500 is illustrated as a logical flow graph, operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the process.

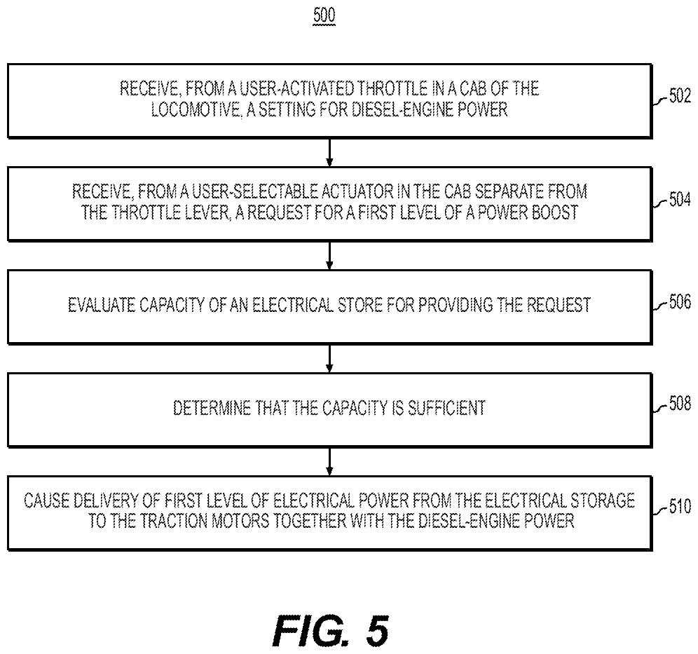

In FIG. 5, the example process 500, at 502, includes processing equipment, or other electronic controllers or processors on a locomotive, receiving a setting for diesel-engine power from a user-activated throttle in a cab of the locomotive. As shown in FIG. 2A, a control module 218 within a rail vehicle such as locomotive 100 may be coupled to HMI 220 for exchanging signals, commands, and other data with an operator within cab 106. FIG. 3 further illustrates that, in some examples, a throttle 304 within mechanical controls may be a handle slidable by the operator through a series of notches, such as TN0-TN8. In some examples, when an operator slides or rotates the handle of throttle 304 to its leftmost position, throttle 304 assumes a notch setting of TN8, which represents a setting or request for the delivery of maximum power from engine 202 to traction motor 212.

In a second step of 504 in FIG. 5, processing equipment such as control module 218 receives a request for a first level of a power boost from a user-selectable actuator in the cab separate from the throttle lever. As shown in FIG. 3, various mechanisms may qualify as a user-selectable actuator for performing the disclosed functions. For instance, soft keys 312 including increment key 314 and notch level icon 318 may be programmed to deliver signals to control module 218 when pressed by an operator. Similarly, increment icon 320 could alternatively or additionally be programmed within monitor 310 to deliver signals to control module 218 when pressed by an operator. Further, in some situations, boost selector 324 could alternatively or additionally be configured to deliver signals to control module 218 when set by an operator. In each of these examples, among others, the delivered signals set by the operator may include a request for a first level of a power boost for locomotive 100. That first level of power boost may correspond, for instance, with one notch level above TN8, i.e., boost notch TN9B as equivalent to what would otherwise be notch TN9 on throttle 304.

Step 506 of the method includes the processing equipment such as control module 218 evaluating capacity of an electrical store for providing the request for a first level of a power boost. As shown in FIG. 2A, the electrical store may be battery 208 or similar technologies that maintain electrical charge for later usage. The electrical store may be continuously or periodically refurbished or recharged, such as through regenerative braking or other known techniques. As also indicated in FIG. 2A, control module 218 is coupled to battery 208 via control bus 220 and can assess an amount of electrical energy stored in battery 208 compared with an amount of electrical energy presently required to fulfill the request for a first level of a power boost. If the stored energy exceeds the needed energy for fulfilling the request, control module 218 can determine that the capacity is sufficient, as indicated in step 508.

In step 510, processing equipment such as control module 218 then causes delivery of electrical power commensurate with the first level from the electrical storage to the traction motors together with the diesel-engine power. As shown in FIG. 3, boost notches, such as TN9B, will exceed the power level from throttle notch TN8. Accordingly, when throttle 304 is set at the maximum power value of TN8, signal generated from one of the operator-actuatable devices such as increment key 314, increment icon 320, or boost selector 324 to indicate a request for auxiliary power at TN9B will cause a draw on electrical power within the electrical storage. Control module 218 can cause a step increase in electrical power provided to traction motor 212 to be combined with the maximum power provided by engine 202 to traction motor 212. Accordingly, locomotive 100 will be able to operate with propulsion beyond the maximum capacity of engine 202 and can do so on demand from the selection of inputs by the operator distinct from throttle 304.

In other situations, the delivery of electrical power from the electrical storage in step 510 will supplement power from engine 202 operating at a power level below a maximum setting, i.e., below notch TN8. For instance, when locomotive 100 is operated in a residential area and set at a lower notch, such as TN3, to minimize emission of exhaust and noise, the delivery of electrical power from the electrical storage in step 510 may increase tractive effort with supplemental electrical power from battery 212 such that locomotive 100 operates in a boost zone at the equivalent of TN5, i.e., “TN5B.”

Those of ordinary skill in the field will appreciate that the principles of this disclosure are not limited to the specific examples discussed or illustrated in the figures. For example, while on-demand power boost has been discussed in the context of retrofitting boost notches into an existing locomotive, additional or different inputs selectable by an operator within a new design for a locomotive cab are feasible. Moreover, while the present disclosure addresses boost capacity provided by an electrical storage such as battery 208, any supplemental or auxiliary power source within locomotive 100 would suffice to be accessed by the boost notches of the present disclosure. In addition, boost notches and enhanced power delivery are not limited to extension beyond a maximum throttle setting. The principles of boosting existing power delivery are applicable from any throttle setting in which the operator could benefit and are consistent with the examples and techniques disclosed and claimed.

### INDUSTRIAL APPLICABILITY

The present disclosure provides systems and methods for boosting propulsion of a locomotive with an on-demand request from the operator. When a throttle is set to deliver power from a power source, such as a diesel-electric engine, an operator can select actuators separate from the throttle to request that a control module deliver additional electrical power from an electrical storage. The actuators may have many forms within the locomotive cab, including soft keys or a touchscreen on a computer monitor or mechanical switches. The actuators provide boost notches of additional power beyond the typical eight notches on the throttle and can make efficient use of extra power capacity in tractive motors. Existing locomotives may be inexpensively retrofitted with the actuators, often with a simple software upgrade affecting the computer monitor and the control module.

As noted above with respect to FIGS. 1-5, a rail vehicle such as locomotive 100 includes a diesel-electric engine 202, a battery 208, at least one traction motor 212, a cab 106, and a control module 218. The cab is configured to house an operator of the locomotive and contains controls adjustable by the operator to affect movement of locomotive 100. The controls may include a throttle 304 adjustable to set a total power to be provided to traction motor 212 and at least one actuator separate from throttle 304. The actuator is adjustable to set an additional amount of power to be provided from battery 208 to traction motor 212. The actuators may include, for example, soft keys 312 in monitor 310, an increment icon 320 on a touchscreen of monitor 310, or a boost selector 324, among other possibilities.

In the examples of the present disclosure, locomotive 100 with a power boost mode accessible on-demand provides enhanced versatility in handling locomotive 100. By giving the operator control over added propulsion, the on-demand boost permits the operator to react to mission demands for added power at least during transient conditions, such as unexpected inclines, tunnel lengths, and acceleration demands. The on-demand boost can be configured with boost notches for additional power that resemble the traditional fixed notches within throttle 304, and can be installed with few, if any, physical changes to a locomotive cab. The boost capability can be easily retrofitted into existing equipment with software upgrades. Implementation of the on-demand boost could also result in dispatching lower locomotive power within a consist, improve fuel economy for locomotive 100, and reduce duty-cycle exhaust emissions.

Unless explicitly excluded, the use of the singular to describe a component, structure, or operation does not exclude the use of plural such components, structures, or operations or their equivalents. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Terms of approximation are meant to include ranges of values that do not change the function or result of the disclosed structure or process. For instance, the term “about” generally refers to a range of numeric values that one of skill in the art would consider equivalent to the recited numeric value or having the same function or result. Similarly, the antecedent “substantially” means largely, but not wholly, the same form, manner or degree, and the particular element will have a range of configurations as a person of ordinary skill in the art would consider as having the same function or result. As an example, “substantially parallel” need not be exactly 180 degrees but may also encompass slight variations of a few degrees based on the context.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A power control system for a locomotive, comprising:
a throttle configured to indicate a first amount of primary power to be provided from a primary power source to one or more traction motors of the locomotive;
a user-selectable actuator, separate from the throttle, configured to select a second amount of auxiliary power to be provided from an electrical storage to the one or more traction motors; and
a control module configured to cause, in response to the user-selectable actuator selecting a second amount of auxiliary power, delivery of at least some of the second amount of auxiliary power to the one or more traction motors.

2. The power control system of claim 1, wherein the throttle includes throttle notches indicating the first amount of primary power and the user-selectable actuator includes boost notches indicating the second amount of auxiliary power.

3. The power control system of claim 2, wherein the primary power source is a diesel engine, the electrical storage is a battery, and the throttle is positioned at a maximum one of the throttle notches.

4. The power control system of claim 2, wherein the primary power source is a diesel engine, the electrical storage includes a battery, and the throttle is not positioned at a maximum one of the throttle notches.

5. The power control system of claim 1, wherein the user-selectable actuator comprises a computer monitor.

6. The power control system of claim 5, wherein the user-selectable actuator comprises soft key input to the computer monitor.

7. The power control system of claim 5, wherein the user-selectable actuator comprises touchscreen input to the computer monitor.

8. The power control system of claim 1, wherein the user-selectable actuator comprises one or more mechanical switches.

9. A locomotive, comprising:
a diesel-electric engine;
an electrical storage;
traction motors coupled to the diesel-electric engine and to the electrical storage;
a cab configured to house an operator of the locomotive, the cab containing controls adjustable by the operator to affect movement of the locomotive, the controls comprising:
a throttle lever adjustable to set a total power to be provided to the traction motors for propelling the locomotive, and
an actuator, separate from the throttle lever, adjustable to set a second amount of auxiliary power to be provided from the electrical storage to the traction motors; and
a control module, coupled to the diesel-electric engine and to the electrical storage, configured to cause delivery of the second amount of auxiliary power to the traction motors, in response to the actuator being set at the second amount of auxiliary power.

10. The locomotive of claim 9, wherein the throttle lever has notches for sequentially adjusting the total power, and the actuator has boost notches for sequentially adjusting the auxiliary power added to the total power.

11. The locomotive of claim 10, wherein the actuator comprises one of a soft key or a touchscreen input on a computer monitor selectable by the operator.

12. The locomotive of claim 10, wherein the actuator comprises a physical switch settable by the operator.

13. The locomotive of claim 9, wherein the actuator signals the control module to cause delivery of the second amount of auxiliary power to the traction motors when the total power set by the throttle lever is a maximum value of the diesel-electric engine.

14. A method for executing a power boost in a locomotive, comprising:
receiving, from a user-activated throttle in a cab of the locomotive, a setting for diesel-engine power from a diesel-electric engine for driving traction motors of the locomotive;
receiving, from a user-selectable actuator in the cab separate from the user-activated throttle, a request for a first level of the power boost for driving the traction motors; and
causing a delivery of a first amount of electrical power commensurate with the first level from an electrical storage to the traction motors together with the diesel-engine power.

15. The method of claim 14, further comprising:
receiving, from the user-selectable actuator, a request for a second level of the power boost higher than the first level; and
causing the delivery to include a second amount of electrical power commensurate with the second level from the electrical storage to the traction motors together with the diesel-engine power.

16. The method of claim 15, further comprising:
receiving, from the user-selectable actuator, another request for the first level of the power boost; and
causing the delivery to revert to the first amount of electrical power.

17. The method of claim 15, further comprising:
receiving, from the user-activated throttle, a setting for delivery of decreased diesel-engine power to the traction motors;
causing the delivery of the decreased diesel-engine power to the traction motors; and
ceasing the power boost.

18. The method of claim 14, further comprising:
evaluating capacity of the electrical storage for providing the request for the first level of the power boost to the traction motors; and
determining that the capacity is sufficient for providing the request to the traction motors.

19. The method of claim 14, further comprising:
evaluating the power boost over time with respect to temperature rise in the traction motors; and
curtailing the power boost if the temperature rise exceeds thermal ratings for the traction motors.

20. The method of claim 14, wherein the causing the delivery of the first amount of electrical power is in response to the diesel-engine power being a maximum value and the request for the first level of the power boost being received.
